(19) United States
(12) Patent Application Publication
(10) Pub. No.: US 2009/0299773 A1
(43) Pub. Date: Dec. 3, 2009

(54) SYSTEM AND METHOD OF MANAGING AN INSURANCE SCHEME

(75) Inventors: Adrian GORE, Houghton Estate (ZA); Herschel Phillip MAYERS, Johannesburg (ZA); Kenneth Steven RABSON, Johannesburg (ZA)

Correspondence Address: PAUL D. BIANCO;Fleit Gibbons Gutman Bongini & Bianco PL, 21355 EAST DIXIE HIGHWAY, SUITE 115, MIAMI, FL, 33180, US

(73) Assignee: DISCOVERY HOLDINGS LIMITED, Sandton (ZA)

(21) Appl. No.: 12/477,179

(22) Filed: Jun. 3, 2009

(30) Foreign Application Priority Data
Jun. 3, 2008 (ZA) 2008/04810

(51) Int. Cl. G06Q 40/00

(52) U.S. Cl. 705/4

(57) ABSTRACT

A system for managing an insurance scheme includes a benefit module to define at least one insured event for an insured person and to define at least one benefit to be paid out on the occurrence of one of the insured events. A monitoring module monitors any interest rate increases or decreases as set by a financial institution. A calculation module alters the at least one benefit based on any monitored change in interest rate, wherein the amount of the altering is related to the amount of the increase or decrease of the interest rate and an awards module, on the occurrence of the at least one insured event, provides the at least one altered benefit to the insured person.

### BACKGROUND OF THE INVENTION

The present application relates to a system and method of managing an insurance scheme.

The present invention may be implemented by a traditional life insurance plan operator for its members or may be implemented by another party.

Conventionally, insurance policies such as life insurance policies operate on the basis that an insured person, sometimes referred to as an insured life, pays a premium to the life insurer, and the life insurer pays a predetermined sum, referred to as the sum assured, to the insured life or his/her beneficiary on the occurrence of an insured event. Typical insured events are the insured life suffering disability, contracting a dread disease or dying.

Some insurers pay a monthly amount to the insured person or their beneficiary on occurrence of an insured event. This monthly amount stays constant or increases by a predetermined amount over time.

However, what the monthly amounts do not take into account is any increase in interest rates, being the interest that a bank charges a person for a loan. This can be very important for an individual who may have one or more loans from a bank such as a home loan and a vehicle purchase loan.

In certain economic conditions, the central bank of a country will increase interest rates sometimes dramatically to curb inflation. In return, individual banks in the country will increase their interest rate that they are charging to their clients.

An insured person or their beneficially may find themselves in an economic climate where interest rates are climbing rapidly and may be unable to service their debt using their existing monthly payments from the insurer.

The present invention provides a system and method of addressing this.

### SUMMARY OF THE INVENTION

According to one example embodiment, a system for managing an insurance scheme, the system including:
a benefit module to define at least one insured event for an insured person and to define at least one benefit to be paid out on the occurrence of one of the insured events;
a monitoring module to monitor any interest rate increases or decreases as set by a financial institution;
a calculation module to alter the at least one benefit based on any monitored change in interest rate, wherein the amount of the altering is related to the amount of the increase or decrease of the interest rates; and
an awards module to, on the occurrence of the at least one insured event, provide the at least one altered benefit to the insured person.

The calculation module may alter the at least one benefit by a percentage.

The calculation module may alter the at least one benefit by a percentage which is the same as the percentage increase or decrease in the interest rate.

The calculation module may alter the at least one benefit by a percentage which is not the same as the percentage increase or decrease in the interest rate but is related to the percentage increase or decrease in the interest rate.

According to another example embodiment, apparatus for managing an insurance scheme, the apparatus including:
means for defining at least one insured event for an insured person and to define at least one benefit to be paid out on the occurrence of one of the insured events;
means for monitoring any interest rate increases or decreases as set by a financial institution;
means for altering the at least one benefit based on any monitored change in interest rate, wherein the amount of the altering is related to the amount of the increase or decrease of the interest rates; and
means for, on the occurrence of the at least one insured event, providing the at least one altered benefit to the insured person.

### BRIEF DESCRIPTION OF THE DRAWINGS

FIG. 1 is a flow chart illustrating the methodology of an example embodiment;

FIG. 2 is a block diagram illustrating an example system to implement the methodologies described herein;

FIG. 3 is an illustrative example of the methodology and system of FIGS. 1 and 2 applied; and

FIG. 4 is a block diagram illustrating an example of one operating environment of the system in FIG. 2.

### DESCRIPTION OF EMBODIMENTS

The systems and methodology described herein relate to a system and method of managing an insurance scheme such as a life insurance scheme to name one example.

Conventional life insurance schemes operate on the basis that an insured person, referred to as the insured life, pays premiums on a regular basis to the life insurer, specifying a sum assured which is an amount to be paid out on the occurrence of an insured event. For example, on the death of the insured life, a predetermined death benefit is paid to the nominated beneficiaries of the insured life. If the insured life is disabled or suffers a dread disease the same or a different amount is paid out.

The method and system will be described with reference to these kinds of schemes but it will be appreciated that the method and system could equally be applied to other types of insurance schemes.

It will also be appreciated that the system and methodology may be implemented by any relevant person or organisation. For example, the system and methodology may be operated by the organisation which operates the life insurance scheme or may be implemented by another associated organisation. In one example the system and methodology may be implemented by a financial organisation which issues credit cards to its members.

For purposes of illustration only, the system and methodology will be described herein as being operated by the managers of a life insurance scheme.

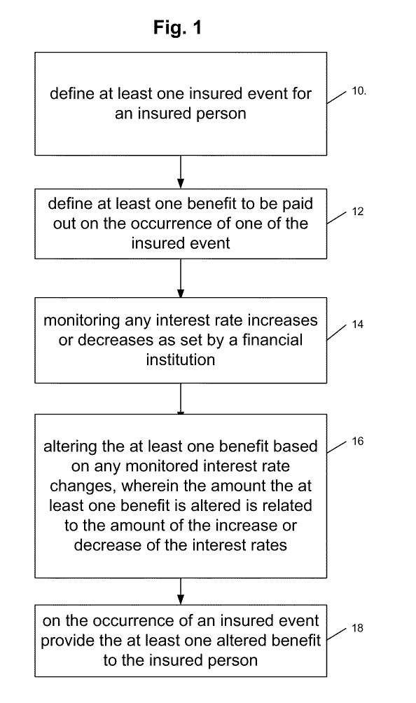

Referring to FIG. 1, at least one insured event is defined (block 10). Typically a plurality of insured events are defined, the plurality of insured events in the example include disability, contracting a dread disease or dying as these are typical of the kind of events which are insured by life insurance schemes. However, it will be appreciated that in other contexts these insured events may be other events such as the birth of a child or changing jobs to name but a few examples.

In any event, the occurrence of an insured event for an insured person of the scheme results in at least one benefit being paid out to the insured person.

The at least one benefit could be any kind of benefit. For example the at least one benefit could be a single lump sum cash payout, the commencement of a periodic cash payout, the at least partial subsidising of expenses in the category of living expenses or the subsidising of health insurance plan premiums to name but a few examples.

In addition, the at least one benefit could be the combination of more than one of the above example benefits.

The at least one benefit will be paid out to the insured person or a nominated beneficiary of the insured person. Typically the benefit is arranged for the insured person but where the insured person has died or is otherwise incapacitated the benefit will be activated for a beneficiary that the insured person has nominated prior to the event.

For purposes of the present invention, the at least one benefit will be described as a periodic cash payout to the insured person or their nominated beneficiary.

The periodic cash payout could be paid out at any given interval but will typically be a monthly payment. The amount of the monthly payment is set by the terms of the insurance agreement between the insurer and the insured person.

In the next step (block 14), any interest rate increases or decreases as set by a financial institution are monitored.

Interest rates in many countries are set centrally by a central bank or other central financial institution. When the central bank increases or the creases of the interest rate, individual financial institutions in the country will increase or decrease the interest rate that they are charging to their clients.

The present invention has application in this kind of scenario but also has application in a scenario where a specific financial institution from whom the insured person or the beneficiary has one or more interest bearing loans increases or decreases the interest rate applying to the one or more loans.

In any event, where a financial institution increases or decreases the interest rate the at least one benefit is altered (block 16) based on any monitored change in the interest rate, wherein the amount of the altering is related to the amount of the increase or decrease of the interest rates.

In the simplest embodiment, the benefit could be increased or decreased by the same percentage as the interest rate increase or decrease.

In another embodiment, the increase or decrease could be is related to by not necessarily the same as the interest rate increase or decrease. The table below illustrates an example of the amount the benefit is altered in response to an interest rate increase.

| Interest rate increase | Benefit altered |
|---|---|
| 1%-1.99% | 5% |
| 2%-2.99% | 7.5% |
| 3%-3.99% | 10% |
| 4%+ | 15% |

Thus the at least one benefit may be altered by a percentage wherein the amount of the percentage is related to the percentage interest rate increase or decrease.

On the occurrence of the at least one insured event, the altered at least one benefit is provided to the insured person (block 18).

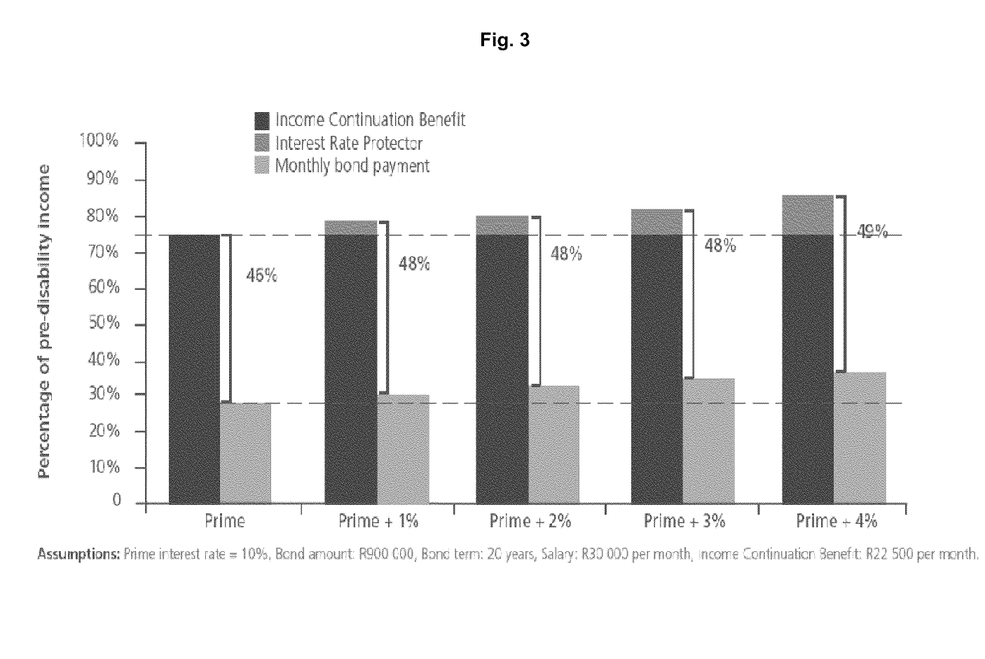

Referring to FIG. 3 of the attached drawings, an example is illustrated whereby the interest rate refers to as the prime rate is increased by different percentages and using the table above, the at least one benefit referred to as the income continuation benefit is increased.

In the illustrated example, the insured person or their beneficiary has a monthly bond payment for a home loan which increases as the prime interest rate increases. Despite this, because of the increase in the income continuation benefit, the disposable income of the insured person is not eroded.

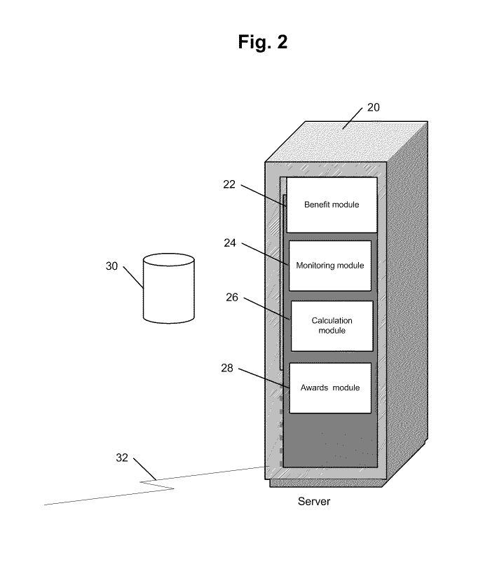

FIG. 2 illustrates an exemplary system for implementing the above methodologies.

A server 20 includes a number of modules to implement the methodologies described above.

A benefit module 22 defines a plurality of insured events for an insured person and defines at least one benefit to be paid out on the occurrence of one of the insured events.

The module 22 is constructed to define the plurality of insured events which in one embodiment includes disability, contracting a dread disease or dying as these are typical of the kind of events which are insured by life insurance schemes. However, it will be appreciated that in other contexts these insured events may be other events.

Once the benefit module 22 defines the plurality of insured events, the module 22 accesses a memory and stores the defined plurality of categories of expenses in the memory.

In one example embodiment, the memory could take the form of the database 28. In other embodiments the memory could be located on the server 20 or on another server not illustrated in this example system. In either case, the memory is in data communication with the module 22 and accessible by the module 22 which is able to read and write data to the memory.

A monitoring module 24 monitors any interest rate increases or decreases as set by a financial institution and as described above.

The monitoring module 24 is constructed to search for the information by accessing an external source of information on a communications network 32 to obtain any changes in the interest rate.

Alternatively or in addition, the monitoring module 24 is constructed to receive data describing any changes in the interest-rate from a user or external computer either via the communications network 32 or via a user input interface such as a use a computer linked directly to the server 20.

Once the monitoring module 24 has obtained any change in the interest rate, the module 24 accesses a memory and stores the defined plurality of categories of expenses in the memory.

In one example embodiment, the memory could take the form of the database 28. In other embodiments the memory could be located on the server 20 or on another server not illustrated in this example system. In either case, the memory is in data communication with the module 24 and accessible by the module 24 which is able to read and write data to the memory.

A calculation module 26 alters the at least one benefit based on any monitored change in interest rate. The calculation module 26 alters the amount related to the amount of the increase or decrease of the interest rates.

The calculation module 26 could calculate the amount to change the interest rate in a number of ways.

In one example embodiment, the calculation module 26 merely alters the amount of the benefit by the percentage amount of the interest-rate change.

In another example embodiment, the calculation module 26 is constructed to calculate for a range of percentage interest rate increases or decreases a corresponding percentage increase or decrease. Thus a number of bands of percentage interest rate increases or the increases are defined and each payment is linked to a corresponding percentage benefit increase or decrease.

The calculation module 26 then calculates the altered benefit amount.

Once the calculation module 26 has calculated the altered benefit amount, this is stored in the database 30.

An awards module 28, obtains on the occurrence of an insured event, the altered benefit amount and provides the at least one altered benefit to the insured person.

The calculation module 26 and the awards module 28 are, in one example embodiment, constructed to calculate the altered benefit periodically such as monthly and to pay this out.

The system includes at least one associated database 30 for storing data to be used by one or more of the above referenced modules.

In addition, the server is typically connected to a communications network 32 for communications with other computers to implement the methodologies described above.

The modules described above may be implemented by a machine-readable medium embodying instructions which, when executed by a machine, cause the machine to perform any of the methods described above.

In another example embodiment the modules may be implemented using firmware programmed specifically to execute the method described herein.

It will be appreciated that embodiments of the present invention are not limited to such architecture, and could equally well find application in a distributed, or peer-to-peer, architecture system. Thus the modules illustrated could be located on one or more servers operated by one or more institutions.

It will also be appreciated that in any of these cases the modules form a physical apparatus with physical modules specifically for executing the steps of the method described herein.

### Operating Environment

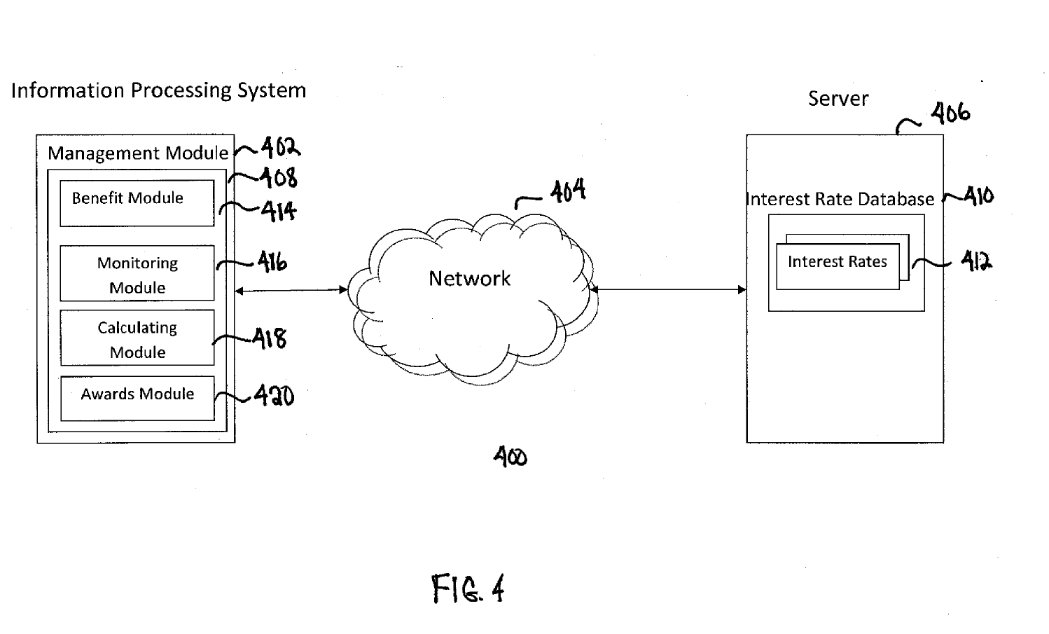

According to one embodiment of the present invention, as shown in FIG. 4, a system and method of 400 for managing an insurance scheme/product is shown. In one embodiment, the system 400 includes one or information processing systems 402 associated with an insurance provider, a network 404, and one or more servers 406. It should be noted that the information processing system 402 is not restricted to being associated with the entity providing insurance to individuals, but can be associated with another entity as well. The insurance provider can provide one or more types of insurance such as a (but not limited to) life insurance scheme to name one example and/or medical insurance to individuals.

The network 404, in one embodiment, is a wide area network, local area network, wireless network, or the like. The information processing system 402 includes a management module 408. The management module 408, in one embodiment, manages an insurance scheme/product. For example, the management module 408, in one example, manages a life insurance product. In this example, the management module 408 manages the benefits of the life insurance product such as a benefit payout by adjusting a monthly benefit payout to an insured person (or beneficiary) based on one more interest rates set by one or more financial institutions.

In one embodiment, the server 406 comprises a database 410 including interest rate information 412 that the management module 408 uses to manage the insurance scheme/product. The management module 408 generates or transforms the interest rate information 412 into an adjustment value for the insurance benefits. This process was discussed in greater detail above. The management module 408, in one embodiment, includes a benefit module 414, a monitoring 416, a calculating module 418, and an awards module 420. This modules 414, 416, 418, 420 are discussed in greater detail below. It should be noted that although this modules 414, 416, 418, 420 are shown as residing within the management module 408, one or more of these modules can reside outside of the management module 408 within the system 402 and/or across multiple information processing systems as well.

The operational flows shown in FIG. 1 illustrate one example of managing an insurance product according to one embodiment of the present invention. In particular, FIG. 1 shows a process performed by the management module 408 and its components 414, 416, 418, 420 within the information processing system(s) 402.

### Non-Limiting Examples

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

Although the various embodiments of the present invention are described in the context of a fully functional computer system, those skilled in the art will appreciate that embodiments are capable of being distributed as a program product via CD or DVD, e.g. CD, CD ROM, or other form of recordable media.

1. A system for managing an insurance scheme, the system including:
a benefit module to define at least one insured event for an insured person and to define at least one benefit to be paid out on the occurrence of one of the insured events;
a monitoring module to monitor any interest rate increases or decreases as set by a financial institution;
a calculation module to alter the at least one benefit based on any monitored change in interest rate, wherein the amount of the altering is related to the amount of the increase or decrease of the interest rates; and
an awards module to, on the occurrence of the at least one insured event, provide the at least one altered benefit to the insured person.

2. A system according to claim 1 wherein the calculation module alters the at least one benefit by a percentage.

3. A system according to claim 2 wherein the calculation module alters the at least one benefit by a percentage which is the same as the percentage increase or decrease in the interest rate.

4. A system according to claim 2 wherein the calculation module alters the at least one benefit by a percentage which is not the same as the percentage increase or decrease in the interest rate but is related to the percentage increase or decrease in the interest rate.

5. Apparatus for managing an insurance scheme, the apparatus including:
means for defining at least one insured event for an insured person and to define at least one benefit to be paid out on the occurrence of one of the insured events;
means for monitoring any interest rate increases or decreases as set by a financial institution;
means for altering the at least one benefit based on any monitored change in interest rate, wherein the amount of the altering is related to the amount of the increase or decrease of the interest rates; and
means for, on the occurrence of the at least one insured event, providing the at least one altered benefit to the insured person.
